(19) United States
(12) Patent Application Publication
(10) Pub. No.: US 2011/0273812 A1
(43) Pub. Date: Nov. 10, 2011

(54) CONTROLLING CURRENT FLOW BY A COIL DRIVE OF A VALVE USING A CURRENT INTEGRAL

(76) Inventors: Johannes Beer, Regensburg (DE); Stephan Bolz, Pfatter (DE)

(21) Appl. No.: 13/143,592

(22) PCT Filed: Dec. 16, 2009
(86) PCT No.: PCT/EP2009/067253

§ 371 Date: Jul. 7, 2011

(30) Foreign Application Priority Data
Jan. 7, 2009 (DE) 10 2009 003 977.5

(51) Int. Cl. H01H 47/00; F02D 41/20

(52) U.S. Cl. 361/152

(57) ABSTRACT

A device (100) and to a method allow for a direct injection valve having a coil drive (110) to reduce in particular the pulse to pulse variation of the volume of fuel injected by the direct injection valve by a control also based on a current integral of the coil drive (110), in particular during a boost phase of a current activation profile of the coil drive (110). The method can be carried out by a computer program.

### CROSS-REFERENCE TO RELATED APPLICATIONS

This application is a U.S. National Stage Application of International Application No. PCT/EP2009/067253 filed Dec. 16, 2009, which designates the United States of America, and claims priority to German Application No. 10 2009 003 977.5 filed Jan. 7, 2009, the contents of which are hereby incorporated by reference in their entirety.

TECHNICAL FIELD

The present invention relates to the technical field of the actuation of coil drives for a valve, in particular a fuel direct injection valve for an engine of a motor vehicle.

### BACKGROUND

In order to operate modern internal combustion engines and to comply with strict emission limiting values, an engine controller determines, by means of what is referred to as the cylinder charge model, the mass of air which is enclosed in a cylinder per working cycle. In accordance with the modeled mass of air and the desired ratio between the air quantity and the fuel quantity (Lambda), the corresponding fuel quantity setpoint value (MFF_SP) is injected via an injection valve. This ensures that the fuel quantity to be injected is to be dimensioned in such a way that a value for Lambda which is optimum for the exhaust gas post-treatment in the catalytic converter is present. For direct-injecting spark ignition engines with internal formation of the mixture, the fuel is injected directly into the combustion chamber at a pressure in the range from 40 to 200 bar.

Main requirements made of the injection valve are that it be sealed against an uncontrolled outflow of fuel, that the jet of the fuel to be injected be prepared, and also that the pre-controlled injection quantity be metered in a precisely timed fashion. In particular in the case of supercharged direct-injecting spark ignition engines, a very large degree of quantity spread of the required fuel quantity is necessary. It is therefore necessary, for example for the supercharged operating mode at the motor full load, to meter a maximum fuel quantity MFF_max per working cycle, while in the operating mode near to idling a minimum fuel quantity MFF_min has to be metered. The two characteristic variables MFF_max and MFF_min define here the limits of the linear working range of the injection valve. This means that there is a linear relationship between the injection time (electrical actuation period (Ti)) and the injected fuel quantity per working cycle (MFF) for these injection quantities.

For direct injection valves with a coil drive, the quantity spread, which is defined as the quotient between the maximum fuel quantity MFF_max and the minimum fuel quantity MFF_min, is approximately 15. For future engines with the emphasis on CO₂ reduction, the cubic capacity of the engines is reduced and the rated power of the engine is maintained or even increased by means of corresponding engine charging mechanisms. As a result, the demands which are made of the maximum fuel quantity MFF_max correspond at least to the demands made of an induction engine with a relatively large cubic capacity. The minimum fuel quantity MFF_min is, however, determined, and therefore reduced, by means of operation near to idling and the minimum mass of air under overrun conditions of the engine with a reduced cubic capacity. This results in increased demand both in terms of the quantity spread and the minimum fuel quantity MFF_min for future engines. However, in the case of injection quantities which are smaller than the minimum fuel quantity MFF_min, both an unacceptable pulse-to-pulse variation of the injection quantity as well as a variation in the average injection quantities between the different injection valves of an engine occur.

The characteristic curve of an injection valve defines the relationship between the injected fuel quantity MFF and the time period Ti of the electrical actuation (MFF=f(Ti)). The inverse of this relationship Ti=g(MFF_SP) is utilized in the engine controller in order to convert the setpoint fuel quantity (MFF_SP) into the necessary injection time. The influencing variables which are additionally included in this calculation, such as the fuel pressure, internal cylinder pressure during the injection process as well as possible variations in the supply voltage, are omitted here for the sake of simplification.

FIG. 4a shows the characteristic curve of a direct injection valve. In this context, the injected fuel quantity MFF is plotted as a function of the time period Ti of the electrical actuation. As is apparent from FIG. 4a, a working range which is linear to a very good approximation occurs for time periods Ti longer than Ti_min. This means that the injected fuel quantity MFF is directly proportional to the time period Ti of the electrical actuation. For time periods Ti shorter than Ti_min, a highly non-linear behavior occurs. In the example illustrated, Ti_min is approximately 0.3 ms.

The gradient of the characteristic curve in the linear working range corresponds to the static flow through the injection valve, i.e. the fuel flow rate, which is continuously attained during the entire valve stroke. The cause of this non-linear behavior for time periods Ti which are shorter than approximately 0.3 ms or for fuel quantities MFF<MFF_min is, in particular, the inertia of an injector spring-mass system and the chronological behavior during the building up or reduction of the magnetic field by a coil, which magnetic field actuates the valve needle of the injection valve. As a result of these dynamic effects, the entire valve stroke is no longer achieved for Ti<Ti_min. This means that the valve is closed again before the structurally predefined final position, which defines the maximum valve stroke, has been reached.

In order to ensure a defined and reproducible injection quantity, direct injection valves are usually operated in their linear working range. This results in a minimum fuel quantity MFF_min per injection pulse which has to at least be provided in order to determine the injection quantity precisely. In the example illustrated in FIG. 4a, this minimum fuel quantity MFF_min is somewhat smaller than 10 mg.

The electrical actuation of a direct injection valve usually occurs by means of current-regulated full-bridge output stages of the engine controller, which make it possible to apply an on-board power system voltage of the motor vehicle to the injection valve, and alternatively to apply a boosting voltage. The boosting voltage is frequently also referred to as boost voltage (Vboost) and can be, for example, approximately 60 V. FIG. 4b shows a typical current actuation profile for a direct injection valve with a coil drive. The actuation is divided into the following phases:

A) Pre-Charge Phase: During this phase with a duration t_pch, the battery voltage Vbat, which corresponds to the on-board power system voltage of the motor vehicle, is applied to the coil drive of the injection valve by means of the bridge circuit of the output stage. When a current setpoint value I_pch_sp is reached, the battery voltage Vbat is switched off by a two-point regulator, and Vbat is switched on again after a further current threshold is undershot. As a result, chronological fluctuation of the current occurs during the pre-charge phase, in which case the maximum value is defined by the current setpoint value I_pch_sp.

B) Boost Phase: The pre-charge phase is followed by the boost phase. For this purpose, the boosting voltage Vboost is applied by the output stage to the coil drive until a maximum current I_peak is reached. As a result of the rapid build up in current, the injection valve opens in an accelerated fashion. After I_peak has been reached, a freewheeling phase follows until the expiry of t_1, during which freewheeling phase the battery voltage Vbat is in turn applied to the coil drive. The time period Ti of the electrical actuation is measured starting from the beginning of the boost phase. This means that the transition to the freewheeling phase is triggered by the predefined maximum current I_peak being reached. The duration t_1 of the boost phase is permanently predefined as a function of the fuel pressure.

C) Off-commutation Phase: After the expiry of t_1, an off-commutation phase follows. Here, the magnetic field of the injector is rapidly reduced by applying a negative boosting voltage −Vboost. The off-commutation phase is timed and depends on the battery voltage Vbat and on the duration t_1 of the boost phase. The off-commutation phase ends after the expiry of a further time period t_2.

D) Holding Phase: The off-commutation phase is followed by what is referred to as the holding phase. Here, in turn, the holding current setpoint value I_hold_sp is adjusted by means of the battery voltage Vbat by means of a two-point controller.

E) Switch-Off Phase: As a result of the voltage being switched off, the coil discharges via a freewheeling diode. The injection valve closes by means of a spring force which is supported by the fuel pressure which is present at the injection valve.

As is apparent from FIG. 4b, the time period Ti of the electrical actuation is defined as the time between the start of the boost phase and switching off of the holding current.

In practice, undesired fluctuations in terms of the actually injected fuel quantity MFF as well as possible variations in the fuel pressure which is present at the injection valve are also due to undesired variations in the current profile which is illustrated in FIG. 4b. Undesired variations in the current profile lead, in particular in the case of small fuel quantities, to a large deviation of the injected fuel quantity from the nominal value. This applies particularly if the fuel quantities MFF are smaller than the minimum fuel quantity MFF_min described above.

16893038

### SUMMARY

According to various embodiments, the current profile for an injection valve can be improved to the effect that even in the case of small fuel quantities a reproducible injection behavior, in particular in terms of fluctuations of the actual injection quantity, is achieved.

According to an embodiment, a device for controlling the flow of current through a coil drive of a valve, in particular of a direct injection valve for an engine of a motor vehicle, comprises: a first switching element for coupling the coil drive to a first voltage source which makes available a first supply voltage, a second switching element for coupling the coil drive to a second voltage source which makes available a second supply voltage which is higher than the first supply voltage, a current measuring apparatus which is coupled to the coil drive and which, when current is flowing through the coil drive, outputs a current measuring signal which is indicative of the flow of current through the coil drive, and a control apparatus which is coupled to the current measuring apparatus and to the two switching elements and which has an integrator for determining a current integral which is indicative of the integral over the current measuring signal from a starting time up to an end time, wherein the control apparatus is configured in such a way that the switched state of at least one of the two switching elements can be controlled as a function of the current integral.

According to a further embodiment, the first supply voltage can be an on-board power system voltage of a motor vehicle. According to a further embodiment, the second supply voltage can be a boosting voltage. According to a further embodiment, the starting time is the start of a boosting phase in a chronological current actuation profile of the coil drive. According to a further embodiment, the end time can be the end of the boosting phase in the chronological current actuation profile of the coil drive. According to a further embodiment, the control apparatus also may have a comparator for comparing the current integral with at least one current integral reference value. According to a further embodiment, the comparator can be configured to compare the current integral with a first current integral reference value. According to a further embodiment, the control apparatus may have a further comparator for comparing the current measuring signal with at least one current measuring signal reference value. According to a further embodiment, at least part of the control apparatus can be implemented by means of a microcontroller. According to a further embodiment, the integrator can be implemented by means of active electronic components. According to a further embodiment, the integrator may have one or two operational amplifiers. According to a further embodiment, the integrator can be implemented by means of a discrete connection of components.

According to another embodiment, a method for controlling the flow of current through a coil drive of a valve, in particular of a direct injection valve for an engine of a motor vehicle, may comprise: measuring a flow of current through the coil drive by means of a current measuring apparatus, outputting of a current measuring signal by the current measuring apparatus, which current measuring signal is indicative of the flow of current through the coil drive, feeding of the current measuring signal to a control apparatus which is coupled to a first switching element and to a second switching element, wherein—the first switching element is provided for coupling the coil drive to a first voltage source which makes available a first supply voltage, and wherein—the second switching element is provided for coupling the coil drive to a second voltage source which makes available a second supply voltage which is higher than the first supply voltage, determining a current integral by means of an integrator which is assigned to the control apparatus, wherein the current integral is indicative of the integral over the current measuring signal from a starting time up to an end time, and controlling the switched state of at least one of the two switching elements as a function of the current integral by means of the control apparatus.

According to yet another embodiment, a computer program for controlling the flow of current through a coil drive of a valve, in particular of a direct injection valve for an engine of a motor vehicle, may be configured to carry out the method as described above, if said computer program is executed by a processor.

### BRIEF DESCRIPTION OF THE DRAWINGS

Further advantages and features of the present invention emerge from the following exemplary description of various embodiments. The individual figures of the drawing of this application are to be considered merely as schematic and not true to scale.

FIG. 1 shows a device for controlling the flow of current through a coil drive of a direct injection valve, wherein a current integral of the coil drive is used as the feedback variable, which current integral is determined by an integrator which is implemented by means of a microprocessor.

FIG. 2a shows an integrator which is implemented by means of two operational amplifiers.

FIG. 2b shows an integrator which is implemented by means of discrete components.

FIG. 3a shows a comparator which compares the current integral of the coil drive with a reference value and, if the current integral exceeds the reference value, brings about a change in the switched state of the switching elements T2 and T3 which are illustrated in FIG. 1.

FIG. 3b shows various chronological voltage profiles which are taken into account in the detection of the current integral of the coil drive and in the closed-loop control of the flow of current through the coil drive.

FIG. 4a shows the characteristic curve of a direct injection valve.

FIG. 4b shows variations in the current profile of a direct injection valve.

At this point it is to be noted that in the drawing the reference symbols of components which are the same or which correspond to one another are identical or differ from one another merely in their first digit.

In addition it is to be noted that the embodiments described below merely constitute a restricted selection of possible embodiment variants. In particular it is possible to combine the features of individual embodiments with one another in a suitable way, so that for a person skilled in the art the embodiment variants which are explicitly presented here would be considered to make public disclosure of a multiplicity of various embodiments.

### DETAILED DESCRIPTION

According to a first aspect, a device for controlling the flow of current through a coil drive of a valve, in particular of a direct injection valve for an engine of a motor vehicle, is described. The described device has (a) a first switching element for coupling the coil drive to a first voltage source which makes available a first supply voltage, (b) a second switching element for coupling the coil drive to a second voltage source which makes available a second supply voltage which is higher than the first supply voltage, (c) a current measuring apparatus which is coupled to the coil drive and which, when current is flowing through the coil drive, outputs a current measuring signal which is indicative of the flow of current through the coil drive, and (d) a control apparatus which is coupled to the current measuring apparatus and to the two switching elements and which has an integrator for determining a current integral which is indicative of the integral over the current measuring signal from a starting time up to an end time. According to various embodiments, the control apparatus is configured in such a way that the switched state of at least one of the two switching elements can be controlled as a function of the current integral.

The control device according to various embodiments is based on the recognition that the flow of current through the coil drive can be set particularly accurately if the flow of current through the coil drive is not used directly as an output variable for the actuation of the first and/or the second switching element but rather an integral over the flow of current is used. In this context, the term flow of current is understood to be the current strength of a flow of current through the coil drive. The flow of current is usually a time-dependent variable which, in the case of the coil drive of a direct injection valve for an engine of a motor vehicle, is correlated chronologically with the crankshaft angle at a particular time.

In the control device according to various embodiments, the current integral for the actuation of the first and/or the second switching element is used. Since, owing, inter alia, to the different voltage levels of the two switching elements, the current integral depends, in turn, on the position of the first and/or the second switching element, the current integral constitutes a feedback signal within a controller with feedback. The control device according to various embodiments therefore has a closed-loop control circuit, at least within a time interval which is defined by the starting time and the end time. The control device according to various embodiments can therefore also be referred to as a closed-loop control device.

The current measuring apparatus may be, for example, an ohmic resistor which is connected in series with the coil drive.

The current integral can be measured within various phases of the current actuation profile for the coil drive and used to perform open-loop and/or closed-loop control of the application of the voltage to the coil drive. Even if the time period between the starting time and the end time is comparatively short, the current integral constitutes a particularly reliable feedback variable in comparison with the simple current measuring signal.

The use of the current integral as a feedback variable has the advantage that, in the case of injection of fuel, undesired pulse-to-pulse variations with respect to the quantity of the injected fuel can be considerably reduced. This is the case, in particular, if only a particularly small fuel quantity is to be injected, which quantity is smaller than a minimum fuel quantity which can be applied with conventional injection valves, operated only in a linear working range, into the combustion chamber of an engine. An injection valve which is controlled with the control device according to various embodiments can therefore inject even relatively small fuel quantities with a high quantity accuracy. The two switching elements can preferably be actuated in ways that are correlated with one another. In particular, it is possible to prevent both the first switching element and the second switching element being in a closed state at the same time. This would specifically have the result that, owing to a “short-circuit current” between the two voltage sources which flows past the coil drive, one of the two supply voltages would collapse. Of course, both switching elements can also be present in the opened state at a particular time, with the result that, as a result, none of the two voltage sources is coupled to the coil drive.

The use of the current integral as a feedback variable also has the advantage that temperature fluctuations, which have an adverse effect on the respective injection quantity and, in particular, on the pulse-to-pulse constancy of the injection quantity of various injection processes through the same injection valve in conventionally actuated direct injection valves, can be at least approximately compensated. This applies both to the injection valve and to an electrical output stage with which the coil drive of the injection valve is driven.

According to one exemplary embodiment, the first supply voltage is an on-board power system voltage of a motor vehicle. The on-board power system voltage can be here the end of charge voltage of a battery of the motor vehicle, which end of charge voltage is determined by the rated voltage of the battery. Given a typical battery rated voltage of, for example, 12 volts, the on-board power system voltage can be, for example, 14 volts.

According to a further exemplary embodiment, the second supply voltage is a boosting voltage. The boosting voltage, which can also be referred to as a boost voltage, can be generated, for example, in a known fashion by means of a DC/DC voltage transformation from the first supply voltage. The boosting voltage can, for example, have a level of 60 volts. According to a further exemplary embodiment, the starting time is the start of a boosting phase in a chronological current actuation profile of the coil drive. The boosting phase may start, in particular, when the second supply voltage is applied to the coil drive as a result of closing of the second switching element. This means that the time of closing of the first switching element coincides with the starting time for determining the current integral.

During the boosting phase, which can also be referred to as the so-called boost phase, the coil drive is operated briefly with an increased coil current. The increased coil current can be of such a magnitude here that, if it were to be maintained for a relatively long time period, it would lead to the destruction of the coil drive.

It is to be noted that, owing to the inductance of the coil drive, the increased coil current is, of course, not reached immediately when the second supply voltage is applied to the coil drive, said time marking the start of the boosting phase. The coil current will instead rise approximately linearly in the direction of the increased coil current—starting from an initial value. It is not absolutely necessary here for the coil current to also actually reach the increased coil current. In particular, when only very small fuel quantities are applied, it is in fact possible to interrupt the coupling of the coil drive to the second supply voltage and, if appropriate, also to the first supply voltage, before the increased coil current is reached by the coil drive.

According to a further exemplary embodiment, the end time is the end of the boosting phase in the chronological current actuation profile of the coil drive. The end of the boosting phase does not necessarily coincide here with a transition of the second switching element from a closed state into an open state. This may be associated, in particular, with the inductance of the coil drive which has already been mentioned above, which inductance ensures that once a coil current has been built up it does not collapse immediately if the supply voltage which has brought about the coil current is no longer present.

The chronological duration and therefore the end of the boosting phase can therefore be defined by the fact that, during the application of the first supply voltage or of the second supply voltage to the coil drive, the coil current becomes greater than a so-called holding current setpoint value which ensures constant opening of the injection valve during a holding phase. This holding current value can be generated, for example, by means of a known two-point controller which operates with the first supply voltage.

According to a further exemplary embodiment, the control apparatus also has a comparator for comparing the current integral with at least one current integral reference value. The current integral reference value can be dimensioned here in such a way that the current integral reaches this current integral reference value before a predetermined peak current is reached. The predetermined peak current can be, for example, a current value which, given a conventional valve actuation strategy in the case of a relatively large injection quantity, leads to decoupling of the coil drive from the second supply voltage.

The current integral reference value can also be of such a magnitude that the current integral reaches this current integral reference value after the predetermined peak current mentioned above is reached. When the reference value is reached, it is possible, for example, for a so-called freewheeling phase within the boosting phase to be aborted and/or for a switch-off phase to be started outside the boosting phase. The freewheeling phase can be determined here by virtue of the fact that, when the first supply voltage is applied to the coil drive, a current which is higher than the holding current setpoint value described above flows through the coil drive within the boosting phase. The switch-off phase is defined by the fact that both switching elements are in the opened state, with the result that neither the first nor the second supply voltage is applied to the coil drive, and the coil current can discharge into the second supply voltage via freewheeling diodes.

According to a further exemplary embodiment, the comparator is configured to compare the current integral with a first current integral reference value. This has the advantage that as a result the value of the minimum injection quantity can be set accurately.

According to a further exemplary embodiment, the control apparatus has a further comparator for comparing the current measuring signal with at least one current measuring signal reference value. This has the advantage that the control apparatus can control the switched state of the first and/or the second switching element not only as a function of the current integral but additionally also as a function of the given current measuring signal at a particular time.

The current measuring signal reference value can be, for example, a predetermined peak value which, given a conventional valve actuation strategy in the case of a relatively large injection quantity within the boosting phase, leads to decoupling of the coil drive from the second supply voltage.

According to a further exemplary embodiment, at least part of the control apparatus is implemented by means of a microcontroller. The part of the control apparatus here can be the integrator, the comparator and/or the further comparator.

The microcontroller can be a programmable processor, with the result that the part of the control apparatus can be implemented by means of a computer program, i.e. by means of software. However, the microcontroller can also be implemented by means of one or more specific electronic circuits, i.e. in hardware, or in any desired hybrid form, i.e. by means of software components and hardware components.

According to a further exemplary embodiment, the integrator is implemented by means of active electronic components. This has the advantage that the current measuring apparatus can be implemented by means of a small ohmic resistor which advantageously avoids a relatively large power loss during the measurement of current. The disadvantage of a small current measuring signal, which is associated with a small resistance value, can be avoided by virtue of the fact that at least one active electronic component is used for a boosting circuit which boosts the voltage dropping across the resistor. This means that the integral of a boosted current measuring signal is measured, with the result that the accuracy of the integration is considerably improved.

According to a further exemplary embodiment, the integrator has one or two operational amplifiers. This has the advantage that a powerful integrator can be implemented in a particularly easy way.

According to a further exemplary embodiment, the integrator is implemented by means of a discrete connection of components. The components which are used for the discrete connection are here, in particular, passive components such as resistors and capacitors and/or active components such as bipolar transistors. This means that no integrated components such as, for example, operational amplifiers or specific ASICs (Application Specific Integrated Circuits) are used for the described boosting circuit. As a result, the integrator can be implemented in a particularly cost-effective way.

According to a further aspect, a method is described for controlling the flow of current through a coil drive of a valve, in particular of a direct injection valve for an engine of a motor vehicle. The described method involves (a) measuring a flow of current through the coil drive by means of a current measuring apparatus, (b) outputting of a current measuring signal by the current measuring apparatus, which current measuring signal is indicative of the flow of current through the coil drive, and (c) feeding of the current measuring signal to a control apparatus which is coupled to a first switching element and to a second switching element. The first switching element is provided here for coupling the coil drive to a first voltage source which makes available a first supply voltage, and the second switching element is provided for coupling the coil drive to a second voltage source which makes available a second supply voltage which is higher than the first supply voltage. The described method also involves (d) determining a current integral by means of an integrator which is assigned to the control apparatus, wherein the current integral is indicative of the integral over the current measuring signal from a starting time up to an end time, and (e) controlling the switched state of at least one of the two switching elements as a function of the current integral by means of the control apparatus.

The method according to various embodiments is based on the recognition that the flow of current through the coil drive can be set particularly accurately if an integral over the flow of current which flows through the coil drive within a predetermined time interval is used as the output variable for the actuation of the first and/or the second switching element. The current integral constitutes here a feedback signal for a controller with feedback, with the result that the control method according to various embodiments describes a closed-loop control operation by means of a closed-loop control circuit.

The method according to various embodiments has the advantage that even particularly small injection quantities which are smaller than the minimum injection quantities of conventional actuation methods for injection valves can be metered with a high accuracy and with a high reproducibility. With the described method, the working range of a direct injection valve, which until now it has only been possible to operate reliably in a linear working range thereof, can be widened to the non-linear working range.

According to a further aspect, a computer program for controlling the flow of current through a coil drive of a valve, in particular of a direct injection valve for an engine of a motor vehicle, is described. The computer program is configured to carry out the method described above, if said computer program is executed by a processor.

In the sense of the present application, mentioning such a computer program is equivalent to mentioning a program element, a computer program product and/or a computer-readable medium, which contains instructions about controlling a computer system, in order to coordinate the method of operation of a system or of a method in a suitable way and in order to achieve the effects which are associated with the method according to various embodiments.

The computer program can be implemented as a computer-readable instruction code in any suitable programming language such as, for example, in JAVA, C++ etc. The computer program can be stored on a computer-readable storage medium (CD-ROM, DVD, Blu-ray Disk, interchangeable disk drive, volatile or non-volatile memory, installed memory/processor etc.). The instruction code can program a computer or other programmable devices such as, in particular, a control unit for an engine of a motor vehicle in such a way that the desired functions are carried out. In addition, the computer program can be made available in a network such as, for example, the Internet, from which it can be downloaded by a user as required.

It is also to be noted that embodiments have been described with reference to different inventive subject matters. In particular, a number of embodiments are described with respect to the device, and other embodiments are described with respect to the method. However, on reading this application a person skilled in the art will understand immediately that, unless explicitly stated otherwise, it is possible not only to combine features which are associated with one type of inventive subject matter, but also to make any desired combination of features which are associated with different types of the inventive subject matters.

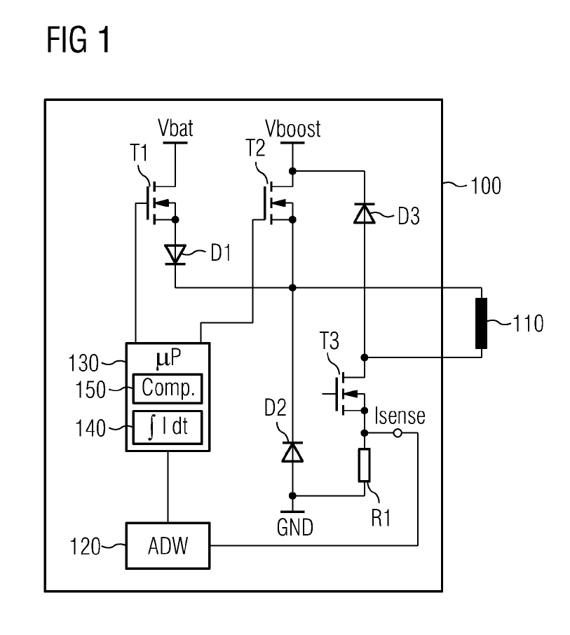

FIG. 1 shows a device 100 for performing closed-loop control of the flow of current through a coil drive 110 of a direct injection valve. The direct injection valve is not illustrated for reasons of clarity.

The closed-loop control device 100 can be coupled to two voltage sources, wherein a first voltage source makes available a first supply voltage Vbat, and the second voltage source makes available a second supply voltage Vboost. According to the exemplary embodiment illustrated here, the first supply voltage Vbat corresponds to an on-board power system voltage or a battery voltage of a motor vehicle. The second supply voltage Vboost is a boosting voltage or a boost voltage which can be generated from the first supply voltage Vbat by means of a conventional DC/DC conversion, for example.

The coil drive 110 can be coupled to the first supply voltage Vbat via a first switching element T1 which is embodied as a transistor, and to the second supply voltage Vboost via a second switching element T2 which is also embodied as a transistor. A third switching element T3 which is embodied as a transistor connects the coil drive 110 to a current measuring apparatus R1. According to the exemplary embodiment illustrated here, the current measuring apparatus is a simple ohmic resistor R1. If the transistor T3 is activated, i.e. in a low impedance state, the same current therefore flows through the current measuring apparatus R1 as through the coil drive 110. In this case, a voltage Isense drops across the resistor R1 with respect to the ground potential GND, which voltage Isense is directly proportional to the flow of current through the coil drive 110 at a particular time. The voltage Isense is also referred to as a current measuring signal within the scope of this application.

According to the exemplary embodiment illustrated here, the current measuring signal Isense is fed to an analog-to-digital converter 120, which transfers digital signals, which correspond to the respective current measuring signal, to a microprocessor 130 with a predefined sampling frequency. The microprocessor 130 has an integrator 140 and a comparator 150 which is connected downstream of the integrator 140. The integrator 140 forms a current integral which is indicative of the integral over the current measuring signal Isense from a predefined starting time up to a predefined end time. As soon as the current integral exceeds a predefined reference value, the comparator 150 supplies an output signal which causes the microprocessor 130 to activate the two switching elements T1 and T2 in such a way that the flow of current through the coil drive 110 is changed in a suitable way. For this reason, the microprocessor can also be referred to as the control apparatus 130.

The current integral constitutes, within the device 100, a feedback variable which depends on the current measuring signal Isense and performs closed-loop control of the flow of current through the coil drive 110 by actuating the switching elements T1 and T2.

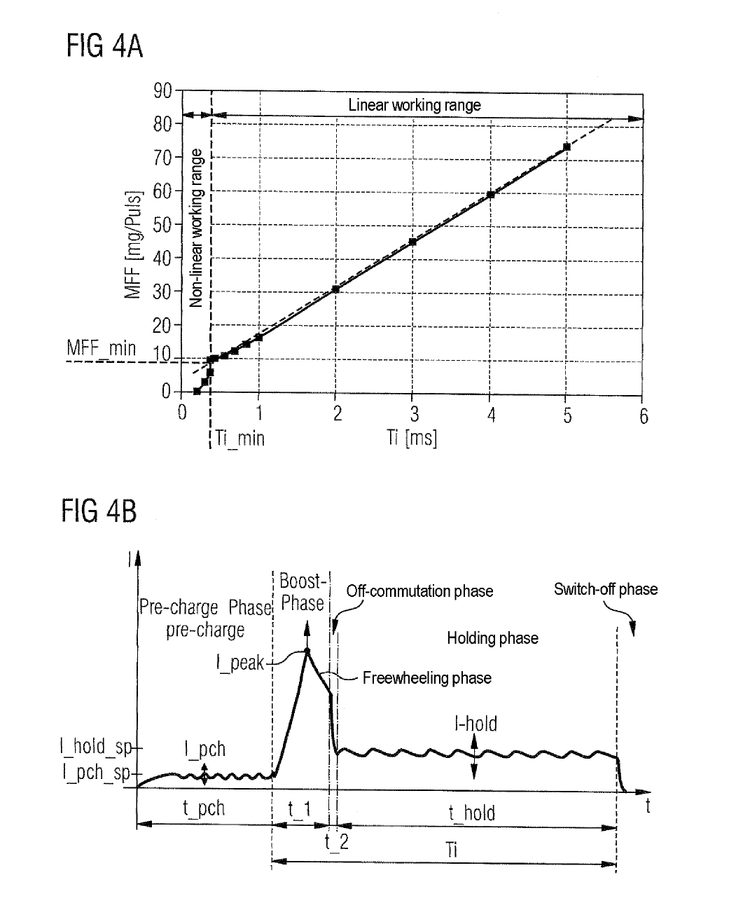

In the text which follows, the method of functioning of the closed-loop control device 100 will be explained in more detail. In this context, a description will firstly be given of a conventional way of actuating the coil drive 110 in which the closed-loop control is performed on the coil current by carrying out a comparison with one or more limiting values and by correspondingly switching the switching elements T1, T2 and T3, but this actuation method does not provide for the current integral to be determined. In this context, reference is also made to the chronological current profile which is illustrated in FIG. 4b, with its different phases.

During the pre-charge phase t_pch, the coil drive 110 is connected to the battery voltage Vbat via the switching element T1, the diode D1 and the switching element T3. The current which increases over time as a result of the inductance of the coil of the coil drive 110 is measured as a voltage drop Isense accross the resistor R1 and is compared with a first limiting value. If the current exceeds the first limiting value, T1 is switched off and the flow of current through the coil of the coil drive 110 is decreased via a freewheeling diode D2. This decrease in the current is additionally driven by the opposing electromotive force of the coil inductance which is described with Lenz's Principle. The decrease in current continues until a second limiting value of the current is reached. Then, the switching element T1 switches on again, after which the coil current increases once more. This procedure repeats periodically, with the result that an average current I_pch flows during the pre-charge phase.

At the start of the switch-on phase of the electrical actuation Ti, the switching element T1 is switched off and the coil drive 110 is then connected to the increased voltage Vboost via the closed switching element T2. As a result, a build up of a current which is as quick as possible is achieved within the coil drive and therefore a drastic acceleration of the switch-on behavior of the injection valve is achieved.

During the application of the increased voltage Vboost, the diode D1 prevents a flow of current across the parasitic substrate diode (not illustrated) from the first switching element T1, embodied as a MOSFET, into the voltage level Vbat. At the same time, the switch-off threshold is raised to a significantly higher, third limiting value. The third limiting value is the maximum current I_peak.

As a result, the coil current continues to increase until the third limiting value or the maximum current I_peak is reached. The second switching element T2 is then switched off and the first switching element T1 is switched on, with the result that the coil drive 110 firstly discharges to Vbat until a fourth limiting value is reached. This ends the boosting phase.

After this, the first switching element T1 also switches off (start of the off-commutation phase), and the discharging of the coil drive 110 now takes place via the freewheeling diode D2 and the regeneration diode D3 until a fifth limiting value is undershot. Then an average holding current I_hold is set in the coil drive 110 for the duration of the holding phase t_hold in the holding phase—as in the pre-charge phase—by periodically switching the first switching element T1 on and off. The complete discharging of the coil drive 110 takes place after the switching off of the two switching elements T1 and T2 by means of the freewheeling diode D2, and by means of the regeneration diode D3 within the scope of the switch-off phase.

In the circuit described in this application, the current integral Integral_I is determined and used to control the switch-off point during the injection of very small fuel quantities. As already described above, the current integral is determined by chronological integration of the current measuring signal Isense. In order to use the current integral in a suitable way during the actuation of the various switching elements, the changes during the course of the activation of the coil drive 110, described in the following points 2) and 3), are necessary:

1) The pre-charge phase (t_pch), the boost phase (t_1) and, if appropriate, also the off-commutation phase (t_2) can occur in the customary way.

2) The boost phase (t_1) and, if appropriate, also the off-commutation phase (t_2) have to be aborted when a predefined reference value for the current integral is reached.

3) During the injection of very small fuel quantities, there is no holding phase (t_hold). Instead, when the set reference value is reached, the discharging of the coil drive 110 is initiated immediately. In this context, the switching elements T1, T2 and T3 are switched off.

As is apparent from FIG. 1, the current measuring signal Isense is fed to the integrator 140 (via the analog-to-digital converter 120). The integrator 140 then makes available an output signal Integral_I, which is compared with a further, sixth limiting value by means of the comparator 150. According to the exemplary embodiment illustrated here, both the integration and the comparison are carried out using digital data. As will be explained in yet more detail below, it is, of course, also possible to integrate an analog signal, and to compare a voltage level, which corresponds to the current integral, with a reference voltage.

When the sixth limiting value is reached, the activation of the coil drive 110 at that particular time is interrupted and the switch-off phase is initiated. The value of the sixth limiting value can be variable by means of the operating software of the closed-loop control device 100 in order to be able to perform closed-loop control on the desired injection quantity.

The influence of varying the current profile for fuel quantities MFF which are smaller than the minimum fuel quantity MFF_min can be compensated by an additional closed-loop controller for the current integral during the boost phase. This closed-loop controller can set, for the boost phase, the setpoint value of the current integral according to various characteristic diagrams KF_Setpoint_Integral_I_x (x=1, 2, 3) by adaptation of the time t_1 of the boost phase. The current integral is obtained here from the following equation:

$$Integral\_I ( t\_End \_Boost ) = {\int }_{t \_ Start \_ Boost}^{t \_ E n d \_ Boost} I ( t ) d t$$

Here, I(t) is the time-dependent current strength through the coil drive. t_Start_Boost is the time when the boost phase starts, and t_End_Boost is the time when the boost phase ends.

The setpoint values KF_Setpoint_Integral_I_x (x=1, 2, 3) can, for example, be stored as characteristic diagrams in a memory.

As a result, when the current integral is taken into account, the following actuation strategy may result for the coil drive:

A) Pre-Charge Phase: the pre-charge phase can run precisely the same way as in the case of conventional closed-loop control of current without taking into account the current integral during the boost phase. In the case of a multiple injection, the pre-charge phase can also be dispensed with.

B) Boost Phase: The following situational differences arise depending on the total duration Ti of the electrical actuation:

B1) Ti>t_1+t_2 (there is a holding phase) or t_1<Ti<t_1+t_2 (there is no holding phase and the injection valve is switched off within the off-commutation phase):

1) If the current strength I through the coil drive reaches the maximum current I_peak, the freewheeling phase then begins. This behavior does not differ from conventional closed-loop control of current without taking into account the current integral.

2) If the Integral_I(t_End_Boost) is of equal magnitude to a first setpoint value KF_Setpoint_Integral_I_1(I_peak, fuel pressure), then t_1=t_End_Boost is true, the freewheeling phase is ended, and the current actuation profile is continued with the switch-off phase. B2) Ti=t_1: Two situations B2i) and B2ii) can be differentiated here:

B2i) Ti>t_peak, where t_peak is the time when the maximum current I_peak is reached. This means that the maximum current I_peak is also actually reached:

1) After I_peak has been reached, a freewheeling phase follows.

2) If the Integral_I(t_End_Boost) is of equal magnitude to a second setpoint value, KF_Setpoint_Integral_I 2(Ti, I_peak, fuel pressure), then t_1=t_End_Boost is true, the freewheeling phase is ended and the current actuation profile is continued with the switch-off phase.

B2ii) Ti<t_peak: this means that the switch-off phase starts before the current through the coil drive reaches I_peak.

If the Integral_I(t_End_Boost) is of equal magnitude to a third setpoint value KF_Setpoint_Integral_I_3(Ti, I_peak, fuel pressure), then t_1=t_End_Boost is true and the current actuation profile is continued with the switch-off phase.

C) Off-commutation Phase: If the off-commutation phase is carried out, there are no changes compared to conventional closed-loop control of current without taking into account the current integral.

D) Holding Phase: If the holding phase is carried out, there are no changes compared to conventional closed-loop control of current without taking into account the current integral.

E) Switch-Off Phase: For the switch-off phase there are also no changes compared to conventional closed-loop control of current without taking into account the current integral. According to the exemplary embodiment illustrated here, a minimum value is selected for the resistor R1 in order to avoid excessive power loss. Accordingly, the voltage drop across R1, which is identical to the current measuring signal Isense, is also in the range of several 100 mV.

However, this small value can make simple analog signal integration more difficult. This applies at any rate when the corresponding analog integrator merely has a capacitor and resistor. Sufficient accuracy of the integration is specifically ensured only if the final value of the integration process is significantly smaller than the input voltage which is to be integrated.

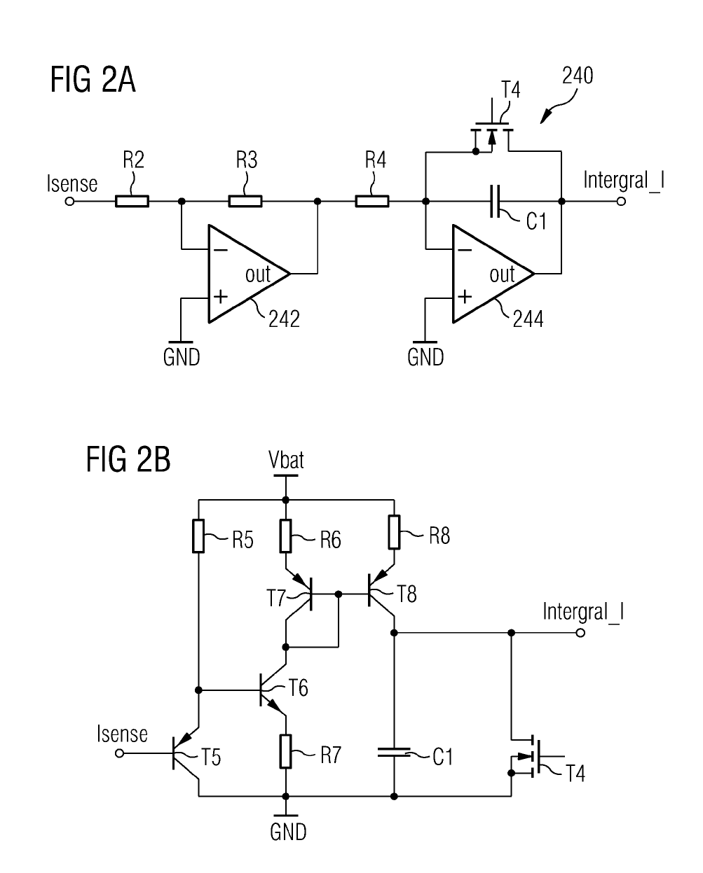

An analog integrator circuit with active components (transistors, operational amplifiers) can avoid this restriction. In this context, two embodiments are conceivable which are illustrated in FIGS. 2a (integrator with operational amplifier) and 2b (integrator with discrete transistor current source).

FIG. 2a shows an analog integrator 240 which has two operational amplifiers, a first operational amplifier 242 and a second operational amplifier 244. The voltage Isense is firstly fed via the resistor R2 to the operational amplifier 242 which is connected as an inverter. If the two resistors R2 and R3 are of equal magnitude, the output level of the operational amplifier 242 is at −Isense.

This voltage is then fed via the resistor R4 to the second operational amplifier 244, which is connected as an inverting integrator. If Isense then has a (positive) voltage value, the voltage at the output of the first operational amplifier 242 is then negative. The flow of current through the resistor R4 also flows through the capacitor C1. Correspondingly, the output voltage Integral_I of the second operational amplifier 244 increases over time and corresponds to the time integral of Isense. The capacitor C1 is short-circuited before the start of the integration phase with the transistor T4 operating as a switch, in order in this way to obtain a defined initial state (0 V) of the Integral_I. The transistor T4 can also be actuated by the actuation circuit (illustrated in FIG. 1).

FIG. 2b shows an analog integrator 240 which is implemented by means of discrete components. A transistor T6 forms, together with a resistor R7, a voltage-controlled current source. In order to compensate the base-emitter threshold voltage of the transistor T6, a PNP-type transistor T5 is connected upstream as an emitter follower. The (positive) base-emitter threshold voltage thereof largely compensates the (negative) base-emitter threshold voltage of the transistor T6, in which case the emitter current of the transistor T5 can be influenced in a suitable way using a resistor R5.

The collector current of the transistor T6 is therefore determined essentially by the value of the voltage Isense and by the value of the resistor R7. The collector current in the transistor T6 also flows through the transistor T7, which forms a current mirror together with a transistor T8. The resistors R6 and R8 serve to compensate any tolerances of the base-emitter threshold voltages of the transistors T7 and T8.

The collector current of the transistor T8 corresponds essentially to the collector current of the transistor T6. If Isense then has a positive voltage value, a current which is proportional thereto will flow through the capacitor C1 and charge it. As a result, the voltage of Integral_I increases in accordance with the time integral of Isense.

The capacitor C1 is short-circuited before the start of the integration phase with the transistor T4 which operates as a switch, in order in this way to obtain a defined initial state T4 (0 V) of Integral_I. The transistor T4 can also be actuated here by the actuation circuit illustrated in FIG. 1.

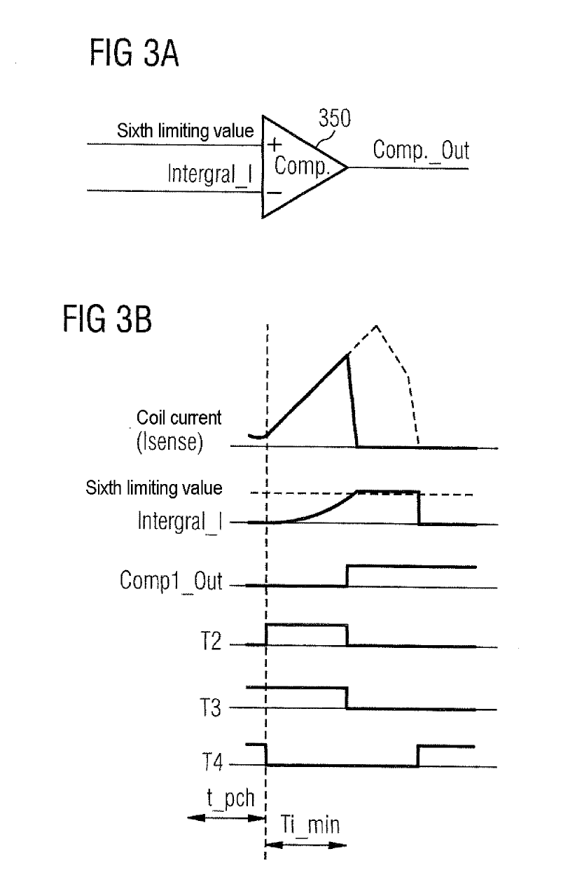

FIG. 3a shows a comparator 350 which compares the current integral Integral_I of the coil drive with the sixth limiting value mentioned above. If the current integral Integral_I exceeds the sixth limiting value, the comparator then brings about a change in the switched states of the switching elements T2 and T3 illustrated in FIG. 1.

FIG. 3b shows various chronological voltage profiles which are taken into account in the detection of the current integral of the coil drive and in the closed-loop control of the flow of current through the coil drive. In the case of a high signal value at T2, T3 and T4, the respective transistor or the respective switching element is switched on (low impedance state), and in the case of a low signal value the respective transistor or the respective switching element is switched off (high impedance state).

It is to be noted that the embodiments described here only constitute a limited selection of possible embodiment variants. It is therefore possible to combine the features of individual embodiments with one another in a suitable way, and therefore, for the person skilled in the art, the embodiment variants which are explicit here are also to be considered to constitute a public disclosure of a multiplicity of different embodiments. This applies, in particular, to a combination of the components illustrated in FIGS. 1, 2a, 2b and 3a. Even if the signal evaluation by means of the microcontroller 130 takes place in a digital fashion in FIG. 1, the functionality of the integrator 140 and/or the comparator 150 can also be implemented by means of analog circuits, as illustrated in FIGS. 2a, 2b and 3a. To summarize, it is still to be noted that various embodiments describe a device and a method which permit, for a direct injection valve with a coil drive (110), in particular the pulse-to-pulse variation of the quantity of fuel injected by the direct injection valve to be reduced, in particular during a boost phase of a current actuation profile of the coil drive (110), by means of a closed-loop control process which is also based on a current integral of the coil drive (110). A computer program with which the specified method can be carried out is also described.

What is claimed is:

1. A device for controlling the flow of current through a coil drive of a valve, the device comprising:
a first switching element for coupling the coil drive to a first voltage source which makes available a first supply voltage,
a second switching element for coupling the coil drive to a second voltage source which makes available a second supply voltage which is higher than the first supply voltage,
a current measuring apparatus which is coupled to the coil drive and which, when current is flowing through the coil drive, outputs a current measuring signal which is indicative of the flow of current through the coil drive, and
a control apparatus
which is coupled to the current measuring apparatus and to the two switching elements and
which has an integrator for determining a current integral which is indicative of the integral over the current measuring signal from a starting time up to an end time,
wherein the control apparatus is configured in such a way that the switched state of at least one of the two switching elements can be controlled as a function of the current integral.

2. The device according to claim 1, wherein the first supply voltage is an on-board power system voltage of a motor vehicle.

3. The device according to claim 1, wherein the second supply voltage is a boosting voltage.

4. The device according to claim 1, wherein the starting time is the start of a boosting phase in a chronological current actuation profile of the coil drive.

5. The device according to claim 1, wherein the end time is the end of the boosting phase in the chronological current actuation profile of the coil drive.

6. The device according to claim 1, wherein the control apparatus also has a comparator for comparing the current integral with at least one current integral reference value.

7. The device according to claim 1, wherein the comparator is configured to compare the current integral with a first current integral reference value.

8. The device according to claim 1, wherein the control apparatus has a further comparator for comparing the current measuring signal with at least one current measuring signal reference value.

9. The device according to claim 1, wherein at least part of the control apparatus is implemented by means of a microcontroller.

10. The device according to claim 1, wherein the integrator is implemented by means of active electronic components.

11. The device according to claim 1, wherein the integrator has one or two operational amplifiers.

12. The device according to claim 10, wherein the integrator is implemented by means of a discrete connection of components.

13. A method for controlling the flow of current through a coil drive of a valve the method comprising:
measuring a flow of current through the coil drive by means of a current measuring apparatus,
outputting of a current measuring signal by the current measuring apparatus, which current measuring signal is indicative of the flow of current through the coil drive,
feeding of the current measuring signal to a control apparatus which is coupled to a first switching element and to a second switching element, wherein
the first switching element is provided for coupling the coil drive to a first voltage source which makes available a first supply voltage, and wherein
the second switching element is provided for coupling the coil drive to a second voltage source which makes available a second supply voltage which is higher than the first supply voltage,
determining a current integral by means of an integrator which is assigned to the control apparatus, wherein the current integral is indicative of the integral over the current measuring signal from a starting time up to an end time, and
controlling the switched state of at least one of the two switching elements as a function of the current integral by means of the control apparatus.

14. A computer program product comprising a computer readable medium storing instructions for controlling the flow of current through a coil drive of a valve which instructions when executed by a processor perform the steps of:
measuring a flow of current through the coil drive by means of a current measuring apparatus,
outputting of a current measuring signal by the current measuring apparatus, which current measuring signal is indicative of the flow of current through the coil drive,
feeding of the current measuring signal to a control apparatus which is coupled to a first switching element and to a second switching element, wherein
the first switching element is provided for coupling the coil drive to a first voltage source which makes available a first supply voltage, and wherein
the second switching element is provided for coupling the coil drive to a second voltage source which makes available a second supply voltage which is higher than the first supply voltage,
determining a current integral by means of an integrator which is assigned to the control apparatus, wherein the current integral is indicative of the integral over the current measuring signal from a starting time up to an end time, and
controlling the switched state of at least one of the two switching elements as a function of the current integral by means of the control apparatus.

15. The device according to claim 1, wherein the valve is a direct injection valve for an engine of a motor vehicle.

16. The method according to claim 13, wherein the valve is a direct injection valve for an engine of a motor vehicle.

17. The method according to claim 13, wherein the first supply voltage is an on-board power system voltage of a motor vehicle.

18. The method according to claim 13, wherein the second supply voltage is a boosting voltage.

19. The method according to claim 13, wherein the starting time is the start of a boosting phase in a chronological current actuation profile of the coil drive.

20. The method according to claim 13, wherein the end time is the end of the boosting phase in the chronological current actuation profile of the coil drive.
